(19) United States
(12) Patent Application Publication
(10) Pub. No.: US 2019/0254306 A1
(43) Pub. Date: Aug. 22, 2019

(54) DISPENSING BEADED COFFEE

(71) Applicant: Curt Jones, Brentwood, TN (US)

(72) Inventor: Curt Jones, Brentwood, TN (US)

(21) Appl. No.: 16/240,432

(22) Filed: Jan. 4, 2019

Related U.S. Application Data
(60) Provisional application No. 62/613,454, filed on Jan. 4, 2018.

(51) Int. Cl. A23G 9/04; F25D 31/00; A23F 5/00

(52) U.S. Cl. CPC A23G 9/04; F25D 2400/30; A23F 5/00; F25D 31/002

(57) ABSTRACT

Systems and methods for preparing and dispensing a coffee product in a frozen bead form, some of which include a vending machine having a freezing chamber for freezing droplets of liquid coffee and dispensing the frozen beads of the coffee product responsive to a vending request.

### CROSS-REFERENCE TO RELATED APPLICATIONS

This application is a non-provisional U.S. patent application claiming the benefit of priority to U.S. provisional patent application No. 62/613,454 filed on Jan. 4, 2018, the entire contents of which is incorporated herein by reference for all purposes.

### BACKGROUND OF THE INVENTION

### Field of the Invention

The present invention relates to dispensing frozen beaded coffee.

### Background

Several vending machines exist on the market. However, these vending machines are not adequate for dispensing frozen beaded coffee directly into a cup.

### SUMMARY OF THE INVENTION

Certain objects, advantages and novel features of the invention will be set forth in part in the description that follows and in part will become apparent to those skilled in the art upon examination of the following or may be learned with the practice of the invention. The objects and advantages of the invention may be realized and obtained by means of the instrumentalities and combinations particularly pointed out in the appended claims.

An object of the present invention is to provide a method as well as a system, device or machine for producing a frozen bead coffee product which, in a simple and reliable way, allows coffee of different types or qualities to be produced and provided as in a frozen bead form.

Some embodiments of the invention are directed to a system for preparing a frozen bead coffee product, which may be incorporated in a vending machine or unit, comprising: a freezing chamber having a bottom wall, a side wall and a top wall, wherein the chamber is maintained at a temperature range of about −260° to about −320° F.; a dispenser for introducing droplets of a liquid at least including coffee into the chamber, wherein the liquid droplets form frozen beads in the chamber; an auger mounted for rotational motion, the auger having an elongated body with external flights extending into the chamber from an aperture in the top wall at an angle which is less than 90° relative to the plane formed by the bottom wall of the chamber, a distal end of the auger being positioned adjacent to the bottom wall of the chamber whereby the frozen beads are lifted by the external flights responsive to the rotational motion of the auger, a sieve mounted for vibrational motion, wherein a proximal end of the auger is positioned adjacent to the sieve, wherein frozen beads lifted by the external flights of the auger are directed to the sieve and sifted by the vibrational motion of the sieve; a discharge chute for receiving frozen beads flowing over the sieve; and a container for receiving the discharged frozen beads, wherein the container is maintained at a temperature below freezing.

In some embodiments, wherein the dispenser for introducing droplets of a liquid including coffee into the chamber comprises a tray having including a plurality of apertures positioned at the top wall of the chamber.

In some embodiments, the auger extends at about 45° relative to the plane formed by the bottom wall of the chamber.

In some embodiments, the sieve includes holes which have a diameter that is less than 2 millimeters.

In some embodiments, liquid nitrogen is introduced to the chamber to maintain the chamber at a temperature range of about −260° to about −320° F.

In some embodiments, the aforementioned system further includes a piston having a surface for receiving a cup thereon and configured for elevating the cup into the container responsive to receiving the discharged frozen beads.

Some embodiments of the invention are directed to a method of preparing a frozen bead coffee product, comprising the steps of: maintaining an internal temperature in a chamber having a bottom wall, a side wall and a top wall within the range of −260° to −320° F.; introducing droplets of a liquid at least including coffee into the chamber from the top wall thereof, whereby the liquid droplets form frozen beads upon contact with the liquid nitrogen gas; rotating an auger having external flights, a distal end of the auger being positioned adjacent to the bottom of the chamber and a proximal end of the auger being adjacent to a sieve, whereby the frozen beads are lifted by the external flights and directed to the sieve; sifting the frozen beads such that a portion of the frozen beads remain on the sieve and a portion of the frozen beads fall through the sieve holes into a collection pan; and directing the remaining portion of frozen beads to a discharge, wherein the discharge chute feeds a container.

In some embodiments of the aforementioned method, the step of maintaining an internal temperature in a chamber having a bottom wall, a side wall and a top wall within the range of −260° to −320° F. further comprising introducing liquid nitrogen into the chamber.

In some embodiments of the aforementioned method, the liquid nitrogen is disposed on the bottom wall of the chamber.

In some embodiments of the aforementioned method, the auger is mounted at an angle which is less than 90° relative to the plane formed by the bottom wall of the chamber.

In some embodiments of the aforementioned method, the rotating auger deposits frozen beads on a supply chute directing the frozen beads to the sieve.

In some embodiments of the aforementioned method, the sieve removes frozen beads less than about 2 millimeters.

In some embodiments, the aforementioned method further includes the step of elevating a cup into the container to receive the discharged frozen beads.

Some embodiments of the invention are directed to a vending machine for preparing and dispensing a frozen bead coffee product, comprising: a chamber having a bottom wall, a side wall and a top wall, wherein the chamber is maintained at an internal temperature of less than or equal to about −18° C.; a supply of a liquid at least including coffee; a dispenser for introducing droplets of the liquid from the supply into the chamber, wherein the liquid droplets form frozen beads in the chamber; an auger mounted for rotational motion, the auger having an elongated body with external flights extending into the chamber from an aperture in the top wall at an angle which is less than 90° relative to the plane formed by the bottom wall of the chamber, a distal end of the auger being positioned adjacent to the bottom wall of the chamber whereby the frozen beads are lifted by the external flights responsive to the rotational motion of the auger; a chute positioned for receiving the frozen beads from the proximal end of the auger, wherein the frozen beads are lifted by the external flights of the auger and deposited into the chute by the proximal end of the auger, a sieve mounted for vibrational motion positioned at the discharge end of the chute, wherein frozen beads and sifted by the vibrational motion of the sieve; a discharge chute for receiving frozen beads flowing over the sieve; a container for receiving the discharged frozen beads, wherein the container is maintained at a temperature below freezing; and a piston having a surface for receiving a cup thereon and configured for elevating the cup into the container responsive to receiving the discharged frozen beads.

In some embodiments of the aforementioned vending machine, the dispenser for introducing droplets of a liquid including coffee into the chamber comprises a tray having including a plurality of apertures positioned at the top wall of the chamber.

In some embodiments of the aforementioned vending machine, the auger extends at about 45° relative to the plane formed by the bottom wall of the chamber.

In some embodiments of the aforementioned vending machine, the sieve includes holes which have a diameter that is less than 2 millimeters.

In some embodiments of the aforementioned vending machine, liquid nitrogen is introduced to the chamber to maintain the chamber at a temperature range of about −260° to about −320° F.

In some embodiments, the aforementioned vending machine further includes a housing including at least the container, the piston, a processor, memory and a display device.

In some embodiments of the aforementioned vending machine, the processor is configured to communicate with the display device and memory to provide a user interface on the display device for facilitating a vending function, wherein the vending function includes detecting receipt of a monetary amount and actuating the discharge of frozen beads to the cup.

### BRIEF DESCRIPTION OF THE DRAWINGS

Various aspects of the present invention are illustrated by way of example, and not by way of limitation, in the accompanying drawings, wherein:

FIG. 1 depicts a diagram of an apparatus for manufacturing frozen beaded coffee products in accordance with the principles of the present invention;

FIG. 2 depicts a block-level diagram of a vending machine for dispensing frozen beaded coffee products into a cup in accordance with the principles of the present invention; and

FIG. 3 depicts a block-level diagram of a controller of the vending machine of FIG. 2 in accordance with the principles of the present invention.

FIG. 4 depicts a block-level diagram of a method of vending beaded frozen coffee products from the vending machine of FIG. 2.

### DETAILED DESCRIPTION OF THE INVENTION

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

Aspects of the present invention are described herein with reference to flowchart illustrations and/or block diagrams of methods, apparatus, systems and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a controller, a general purpose computer, a special purpose computer, or other programmable data processing apparatus to produce a machine, such that the instructions, which executed via the processor of the controller or other programmable data processing apparatus, create means for implementing the functions/acts specified in the flowchart and/or block diagram block or blocks.

These computer program instructions may also be stored in a computer readable medium that can direct the controller, the computer, other programmable data processing apparatus, or other devices to function in a particular manner, such that the instructions stored in the computer readable medium product constitutes an article of manufacture including instructions which implement the function/act specified in the flowchart and/or block diagram block or blocks.

The computer program instructions may also be loaded onto the controller, a computer, other programmable data processing apparatus, or other devices to cause a series of operational steps to be performed on the controller, other programmable apparatus or other devices to produce a controller implemented process such that the instructions which execute on the controller or other programmable apparatus provide processes for implementing the functions/acts specified in the flowchart and/or block diagram block or blocks.

The following description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As will be appreciated by one skilled in the art, aspects of the present invention may be embodied as a method, system, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product on a computer-usable storage medium having computer-usable program code embodied in the medium.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. Aspects of the invention were chosen and described in order to best explain the principles of the invention and the practical application, and to enable others of ordinary skill in the art to understand the invention for various embodiments with various modifications as are suited to the particular use contemplated.

With respect to the description herein, “coffee product” refers to hot coffee, iced coffee, beaded coffee, liquid creamer, beaded creamer, and/or any other coffee additive.

Traditionally, coffee may comprise a hot drink having a distinct aroma and flavor, prepared from coffee beans, which are seeds that can be found inside berries of the coffee plant. However, coffee could be made from other coffee plants. Furthermore, coffee may be prepared with milk, cream, and/or sweeteners. Coffee may also be served cold, such as an iced coffee. In addition, coffee may also be served as a beaded confection and may be served with beaded creamers, milk, and/or flavorings.

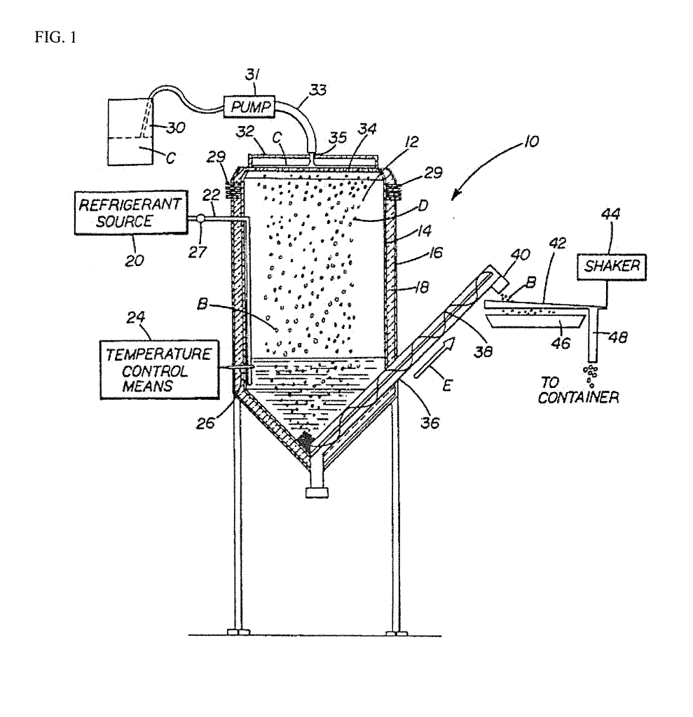

Reference is now made to FIG. 1 showing an apparatus 10 that may be utilized to produce free-flowing, frozen alimentary coffee products (“beaded frozen coffee products”) in accordance with the method of the present invention. It should be recognized that this apparatus 10 is merely being described as an example of one type of apparatus designed for this purpose. Other designs may, of course, be utilized in accordance with the present method to produce the free-flowing, frozen coffee product.

As shown, the apparatus 10 includes a freezing chamber 12 having an inner wall 14 and outer wall 16. Both the walls may be constructed of stainless steel to provide both strength and corrosion resistance. A thick layer of thermal insulating material 18 may be provided between the walls to improve the efficiency of the freezing chamber by reducing the thermal transfer through the walls 14, 16 between the interior of the chamber 12 and the ambient environment.

The chamber 12 may be chilled by the direct addition of refrigerant from a refrigerant source 20 through the delivery line 22. A number of different refrigerants can be utilized although liquid nitrogen is preferred. This material is readily available, relatively inexpensive and relatively inert to food products. It is also sufficiently cold to provide for relatively rapid freezing of the product. As such, it is particularly adapted for utilization in the processing of free-flowing, frozen beaded coffee products in accordance with the present invention. The temperature of the freezing chamber as well as the level of liquid refrigerant may be maintained within a specified range through the utilization of a temperature control means 24 such as a thermostat as is known in the art. More specifically, the temperature control means 24 may be connected to a thermocouple 26. The thermocouple 26 may be positioned to extend into the freezing chamber 12 at a selected height between, for example, 4 to 18 inches above the bottom of the chamber to sense the temperature within the chamber. Where, for example, liquid nitrogen is utilized as the refrigerant, the thermostat is set to maintain the temperature within the chamber 12 at the thermocouple 26 between approximately −300° to −320° F. The positioning of the thermocouple 26, some 4 to 18 inches above the bottom of the chamber 12, provides the necessary reservoir of refrigerant to quick freeze the droplets of the alimentary composition. The ultra-low temperature of the refrigerant limits the formation of ice crystals in the product as it is frozen. Advantageously, by reducing the overall size of the ice crystals being formed, the resulting frozen product has a richer, creamier texture and exhibits a better overall flavor.

For example, when the temperature within the chamber 12 at the thermocouple 26 rises above the set range of operation (i.e. −300° to −320° F.), this is an indication that the level of liquid refrigerant has fallen below the thermocouple. As a result of the operation of the temperature control means 24, a valve 27 is then opened to allow delivery of liquid nitrogen from the source 20 through the line 22 to the chamber 12. Once the liquid refrigerant level within the chamber 12 reaches and contacts the thermocouple 26, the desired level of liquid refrigerant for freezing the composition is restored and the valve 27 is closed.

Of course, alternative temperature or level control systems may be utilized. For example, a number of thermocouples 26 may be positioned at various heights within the chamber 12. The thermocouple 26 at the desired liquid refrigerant level to be maintained is then selected and utilized as described above. In another alternative, a liquid nitrogen level controller such as manufactured and marketed by Minnesota Valley Engineering, Inc. under the trademark CRYO-MED (Model LL-450) may be utilized.

Vents 29 may be provided in the walls 14, 16 near the top of the freezing chamber 12. These vents 29 may serve to release rising nitrogen vapor from the chamber 12 and prevent any build-up in pressure in the chamber or any excess lowering of temperature near the top such that the dropper system is frozen over time. This exhaust can be controlled manually by venting through an exit pipe which may be controlled by a damper. Alternatively, the exhaust gas can be collected under vacuum by the use of an exhaust fan. This cold vapor can be routed to other parts of the process where cold vapors can be utilized such as in storage spaces or with packaging machines.

The first step of the method of the present invention relates to the preparing of a coffee composition (the “composition” denoted as C on FIG. 1) for freezing. Typically, the coffee composition may comprise liquid coffee. However, the coffee composition may be coffee based and may include coffee additives, such as cream, milk, butter and/or eggs. Additional ingredients could include sugar, fruit extracts or some other flavoring component, such as vanilla extract. Alternatively, these additives may be separately formed into frozen beaded coffee products (denoted as beads B on FIG. 1). After preparing the coffee composition comes the step of slowly dripping the composition into the freezing chamber 12. This may be accomplished in a number of ways. For example, as shown in FIG. 1, the composition C may be pumped from a supply container 30 into a dropper system including a tray 32 positioned across the upper end of the freezing chamber 12. More specifically, the composition may be pumped by pump 31 through the tube 33 so as to be delivered through an inlet 35 in the top of the tray that closes the tray to prevent any residual dirt or dust in the air from falling into the composition. The bottom of the tray 32 may include a series of apertures 34 through which the composition drips into the freezing chamber 12. The apertures may have a diameter of between substantially 0.125 and 0.3125 inches so as to provide the desired size droplets of composition for freezing into beads. The size of the droplets and rate of flow may be determined not only by the size of the holes, but the thickness of the composition and in some cases the thickness of the tray.

As the droplets D of composition fall downwardly in the freezing chamber, they contact cold nitrogen gas rapidly vaporizing from the pool of liquid nitrogen P at the bottom of the chamber. As a result of the temperature within the range of −260° to −320° F. (for liquid N2), rapid freezing of the droplets of composition occurs. The small beads B that are produced contain only relatively small ice crystals. The beads B may have a smooth, spherical and/or oblong appearance.

An auger 36 for collecting the beads B may extend into the bottom of the chamber 12. As shown, the auger can be positioned at an angle of approximately 45° with respect to the horizontal. The auger may include flights having a diameter of substantially 1.5″ to 3.5″. By rotating such an auger at substantially 10-100 revolutions per minute, it may be possible to complete collecting of the beads B from the freezing chamber. More specifically, as the auger is rotated, the beads B may be drawn upwardly in the direction of action arrow B on the flights 38. Liquid refrigerant may not necessarily be withdrawn from the freezing chamber as sufficient space exists between the flights 38 and the walls of the auger 36 so as to allow the liquid nitrogen to drain back to the pool P. This space may not necessarily be large enough to allow the passage of the beads B.

Once the beads B reach the top of the auger 36, they may be deposited by means of a chute 40 onto a sieve 42. The sieve 42 is connected to a shaking apparatus 44 as is known in the art. This apparatus 44 serves to vibrate the beads B on the sieve 42. Thus, sifting of the beads B occurs with the relatively large beads having a diameter of, for example, approximately 2 mm or larger remaining on the surface of the sieve while the smaller beads and fragmented portions of broken beads fall through the sieve into the collecting pan 46. That material collected in the pan 46 may be melted and reprocessed by mixing back in with the composition C that is added to the tray 32 as described above.

The larger beads flow over the sieve to a discharge chute 48 where they are deposited into a container (not shown). This container is maintained open for substantially 1-10 minutes in order to allow any residual nitrogen refrigerant retained in or on the surface of the beads to vaporize. Then the container is sealed and placed in a freezer for storage. In order to prevent the beads B from sticking together during storage and thereby maintain their free-flowing character, they must be maintained at a relatively low temperature. More specifically, if the beads B are to be stored for greater than a period of approximately 30 hours, they should be stored in the refrigerator at a temperature of at least as low as −20° F. More preferably, the beads may be stored at a temperature between −30° and −40° F.

Alternatively, if the beads B are to be consumed within a 30-hour period (or shorter period of 10-12 hours for certain compositions), they are to be stored in the freezer at a temperature of −20° F. or above. More preferably, the beads are brought to a temperature between substantially −10° and −20° F. with −15° F. providing the best results. Warmer temperatures may result in the beads sticking together and the product losing its unique free-flowing property which adds to its consumer appeal. When served at a colder temperature, many individuals find that the product is too cold to be fully enjoyed.

In summary, numerous benefits have been described which result from employing the concepts of the present invention. In particular, the method of the present invention allows the preparation, storing and serving of a unique, free-flowing, frozen alimentary product. Because the product is quick frozen, it is smoother and creamier and provides a full-bodied flavor. Advantageously, the resulting product has a certain sophistication that appeals to today's discriminating consumers who want something special.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

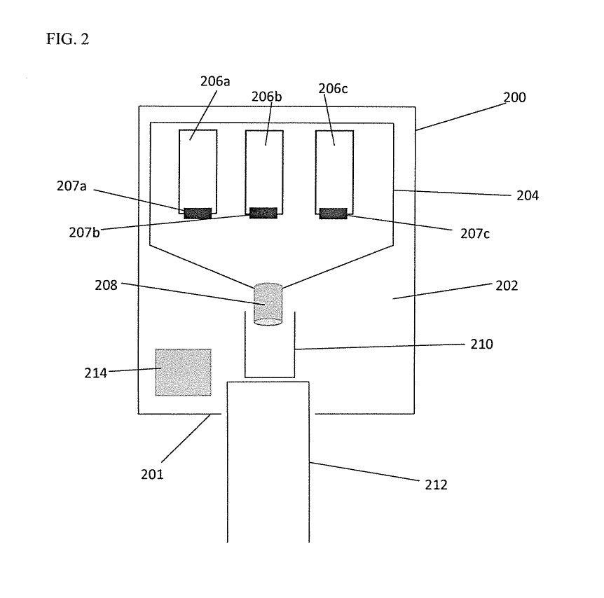

FIG. 2 represents a block-level diagram of a vending machine 200 for dispensing frozen beaded coffee products, such as beads B, into a cup 210 in accordance with the principles of the present invention. The vending machine 200 may not necessarily allow frozen beaded coffee products to be released outside the cup 210 and melt on or outside the vending machine 200.

The vending machine 200 may comprise a dispensing freezer 202. The dispensing of the frozen beaded coffee products into the cup 210 may occur within the dispensing freezer 202. Thus, any frozen beaded coffee product that misses the cup 210 may be retained within the dispensing freezer 202. In some embodiments, the frozen beaded coffee products may remain frozen at about −40° or below. Thus, the dispensing freezer 202 may be kept at about −40° or below. Furthermore, the dispensing freezer 202 may comprise materials of sufficient insulative qualities to retain the temperature within the range of about −40° or below. The dispensing freezer 202 may comprise walls similar to the walls of freezing chamber 12. For example, the dispensing freezer 202 may be formed by materials comprising a vacuum enclosed within the material, rubber, plastics, composites, steel (e.g. multi-layer steel enclosing the vacuum), etc. In other embodiments, the frozen beaded coffee products may remain frozen at normal household freezer temperatures. Thus, the dispensing freezer 202 may be kept at about −18° C. or below. Therefore, some embodiments of the vending machine 200 may keep frozen beaded coffee products frozen within dispensing freezer 202 until cleaned out.

Dispensing freezer 202 may enclose supply freezer 204. Dispensing freezer 204 may comprise an opening 201. The opening 201 may be configured to receive the cup 210 and/or a piston 212 within the dispensing freezer 202. The opening 201 may be positioned below a dispenser 208 such that the cup 210 may be placed onto the piston 212 such that the cup 210 can receive frozen beaded coffee products from the dispenser 208. Furthermore, vending machine 200 may be configured such that the height of the cup 210 may be positioned within the freezer 202 during dispensing. In some embodiments, the dispenser 208 may be configured to be received within the cup 210 during dispensing. In addition, the opening 201 may be configured to fit to the outer surface of the piston 212 such that frozen beaded coffee products may not necessarily roll out the opening 201 when the piston is within the opening 201.

Supply freezer 204 may comprise one or more supply containers 206a, 206b, 206c. Supply freezer 204 may be maintained at a substantially similar temperature to dispensing freezer 202. Furthermore, supply freezer 204 may comprise materials that are substantially similar to dispensing freezer 202. By way of example, supply containers 206a, 206b, and 206c may comprise different respective flavors of frozen beaded coffee product. In other embodiments, one or more supply containers 206a, 206b, 206c may comprise a frozen beaded coffee additive, such as creamer, milk, sugar, etc. Supply containers 206a, 206b, 206c may comprise respective release valves 207a, 207b, 207c that allow contained material to flow through the respective container 206a, 206b, 206c, when the corresponding release valve 207a, 207b, 207c is open. The released material may then flow through supply freezer 204, through dispenser 208, and into cup 210 within the dispensing freezer 202. Thus, frozen beaded coffee product may be formed using the apparatus 10 and stored in containers 206a, 206b, and 206c until sale.

Containers 206a, 206b, 206c may be sufficiently sized to retain a daily, weekly, or monthly vending volume of beaded frozen coffee products. The “vending volume” refers to the amount released from a respective container 206a, 206b, and 206c during a single sale from the vending machine 200. For example, a weekly vending volume may comprise the volume of all sales from the respective container 206a, 206b, 206c during the week. An example weekly vending volume may be from about one gallon to about five gallons. The vending volume of each respective container 206a, 206b, and 206c may not necessarily be the same. For example, a lesser volume of frozen beaded creamer may be released with a large volume of frozen beaded coffee during one sale. As another example, a 50/50 mixture of two different frozen beaded coffee may be released without any creamer beads in a subsequent sale. Each particular vending volume of each respective container 206a, 206b, and 206c may vary based on the selection received via a user interface 214.

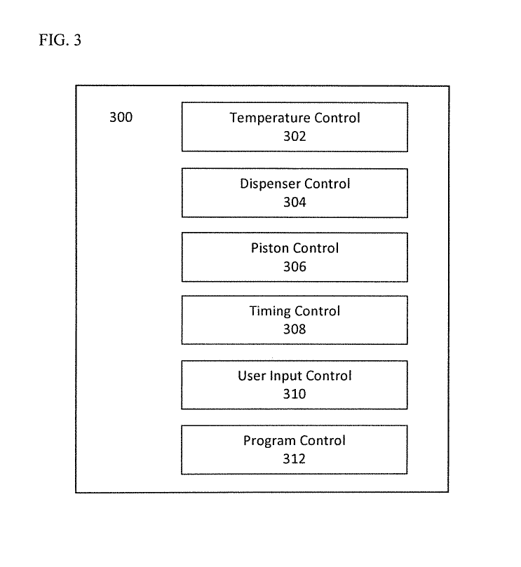

The respective valves 207a, 2071, and 207c may be configured to release a predetermined amount (e.g. the vending amount) of beaded frozen coffee product during each vending cycle. A controller (described with respect to FIG. 3) may signal valves 207a, 207b, and 207c to open and/or close. The controller may signal the respective valves 207a, 207b, and 207c during a vend cycle.

Vending machine 200 may further comprise user interface 214. The user interface 214 may receive input related to the purchase of beaded frozen coffee products. For example, the user interface 214 may receive input defining a cup size, a beaded coffee base type, and/or additive types. The user interface 214 may send the input to the controller via user input control 310. The controller 300 may activate the required controls 302-312 to vend the proper amount and mixture of beaded frozen coffee products into the cup 210. Payment may also be verified through the user input 214.

The piston 212 may raise the cup 210 into the dispensing freezer 202 for vending. Based on the height of the cup 210, the piston 212 may raise the cup such that the dispenser 208 may be inside the top of the cup 210. Furthermore, after the beaded frozen coffee products are dispensed into the cup 210, the cup 210 may be lowered out of the dispensing freezer 202. The purchaser may then remove cup 210 and consume the beaded frozen coffee products. Another cup may then replace cup 210 for subsequent vending.

FIG. 3 represents a block-level diagram of a controller 300 according to the teachings of the present invention. The controller 300 may be any device capable of sending and receiving electronic data over an interface. For example, a microcontroller or a computer could be used. The controller 300 may also perform operations on and/or modify the data it receives such that the controls 302-312 may be regulated.

Some embodiments of the vending machine 200 may have one or more of a temperature control 302, a dispenser control 304, a piston control 306, a timing control 308, a user input control 310, and a program control 312. These respective controls may be embodied on the controller 300. The respective controls may be embodied as hardware circuits or may be software embodiments wherein program code, such as java, C++, etc., manipulates the hardware of a general purpose hardware circuit. Software embodiments may be implemented as low-level code or even as high level code operating within an operating system, such as unix, bsd, Microsoft Windows, iOS, etc.

Controller 300 may comprise a processing unit (CPU), local memory, peripherals and interfaces, and a general purpose input/output (I/O) interface. The CPU may further comprise local storage. Local storage may be used to store variables, constants, etc. for complex calculations. Local memory may interface with the CPU via a memory interface. The memory interface may allow the CPU to store calculated values, variables, constants, or any other important electronic signal onto the physical local memory. The memory interface may include one or more direct memory access controllers. Of course, part or all of the local memory may be committed to program storage, in which data relevant to the operation of the program is stored. Program storage may also be organized into useful data structures such as a stack or heap. The peripherals and interface and the general purpose I/O interface may interface to external input or output devices. Examples of external input or output devices include any electronic device capable of sending or receiving an electronic signal such as keyboards, mice, printers, scanners, digital sensor, analog sensors, Ethernet, analog to digital converters, ADC, UART, USB etc. Program storage, local memory, peripherals and interface, and general purpose I/O interface may be contained on the circuit board of the CPU. In other embodiments, any of these parts may be external to the CPU.

The temperature control 302 may be in electronic communication with dispensing freezer 202 and/or supply freezer 204. The temperature control 302 may regulate the temperature of dispensing freezer 202 and/or supply freezer 204. For example, the temperature of the dispensing freezer 202 and/or supply freezer 204 may be received by the temperature control 302 from respective thermometers within the corresponding freezer 202, 204. Additionally, the temperature control 302 may activate and/or deactivate respective condensers to maintain the appropriate temperatures corresponding to the respective dispensing freezer 202 and/or supply freezer 204.

The dispenser control 304 may be in electronic communication with valves 207a, 207b, and/or 207c. The dispenser control 304 may receive instructions from a user interface, wherein the instructions signal that a purchase has been made. These purchase instructions may include the type and/or amount of beaded frozen coffee product(s) purchased. For example, if a mocha is purchased, the dispenser control 304 may activate the respective valve 207a, 207b, or 207c to release one cup of beaded mocha and/or a second respective valve 207a, 207b, 207c to release one tablespoon of beaded creamer.

The piston control 306 may be in electronic communication with piston 212. The piston 212 may be electrical, pneumatic, and/or hydraulic. Therefore, piston control 306 may send an electrical signal to a control mechanism of the piston 306 (e.g. an electrical motor, a pneumatic compressor, and/or a hydraulic compressor).

The timing control 308 may include a timing circuit in electronic communication with the controller 300. The timing control 308 may provide absolute time, such as UTC or relative time, such as Eastern Time. The timing control may also provide an elapsed time from some starting reference time. The timing control may be in communication with the other controls of the controller 300 such that an elapsed time may be tracked with respect to activation of sensors, such as the thermometer, the heating element 204, etc.

The user input control 310 may be in electronic communication with the control panel 214. The user input control 310 may provide selections made by the user to one of the other components of the vending machine 200 or the controller 300. For example, the user may select volume, temperature, blend, etc. via the user input control 310. The user input control 310 may provide these user selections to one of the other components of the vending machine 200 or the controller 300.

Controls 302-310 may be in electronic communication with the program control 312. Thereby, the program control 312 may receive reported values, such as temperature, time, and volume, from the respective reporting controls 302-312. Receiving values reported from the controls allows for regulation of the vending machine 200 for use in preparing a single serve cup in various sizes at an appropriate temperature.

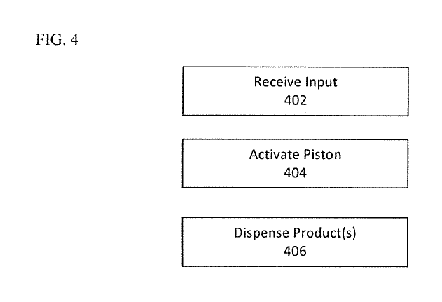

FIG. 4 depicts a block-level diagram of a method of vending beaded frozen coffee products, such as beads, B from the vending machine 200 of FIG. 2. In step 402, the vending machine 200 may receive input, such as input from user interface 214. The user interface 214 may present options and receive input defining a total vending volume, volumes of one or more ingredients, etc. Step 402 may also comprise verification of payment.

In step 404, the vending machine 200 may place the cup 210 on the piston 212. Alternatively, the vending machine 200 may receive the cup 210 onto the piston 212 from the user. The vending machine 200 may then raise the piston 212 until the cup 210 is within the dispensing freezer 202.

In step 406, the vending machine 200 may dispense the appropriate beads B corresponding to the received input from user input 214. The vending machine 200 may activate release valves 207a, 207b, and/or 207c as appropriate to dispense the correct amount of beads B from each container 206a, 206b, 206c. Beads B may be dispensed by the operation of gravity from the container 206a, 206b, 206c to the dispenser 208. The amount of beads may be regulated by a counter, volumetric detector, weight detector, timer, and/or any other mechanism for determining amount. The beads B may pass from the dispenser 208 to the cup 210. The vending machine 200 may lower the piston 212 back down for removal of the cup 210. For example, the user may remove the cup 210 for consumption of the beads B.

The foregoing description has been presented for purposes of illustration and description. It is not intended to be exhaustive or to limit the invention to the precise forms disclosed. Obvious modifications or variations are possible in light of the above teachings. The embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

1. A system for preparing a frozen bead coffee product, comprising:
a freezing chamber having a bottom wall, a side wall and a top wall, wherein the chamber is maintained at a temperature range of about −260° to about −320° F.;
a dispenser for introducing droplets of a liquid at least including coffee into the chamber, wherein the liquid droplets form frozen beads in the chamber;
an auger mounted for rotational motion, the auger having an elongated body with external flights extending into the chamber from an aperture in the top wall at an angle which is less than 90° relative to the plane formed by the bottom wall of the chamber, a distal end of the auger being positioned adjacent to the bottom wall of the chamber whereby the frozen beads are lifted by the external flights responsive to the rotational motion of the auger;
a sieve mounted for vibrational motion, wherein a proximal end of the auger is positioned adjacent to the sieve, wherein frozen beads lifted by the external flights of the auger are directed to the sieve and sifted by the vibrational motion of the sieve;
a discharge chute for receiving frozen beads flowing over the sieve; and
a container for receiving the discharged frozen beads, wherein the container is maintained at a temperature below freezing.

2. The system as recited in claim 1, wherein the dispenser for introducing droplets of a liquid including coffee into the chamber comprises a tray having including a plurality of apertures positioned at the top wall of the chamber.

3. The system as recited in claim 1, wherein the auger extends at about 45° relative to the plane formed by the bottom wall of the chamber.

4. The system as recited in claim 1, wherein the sieve includes holes which have a diameter that is less than 2 millimeters.

5. The system as recited in claim 1, wherein liquid nitrogen is introduced to the chamber to maintain the chamber at a temperature range of about −260° to about −320° F.

6. The system as recited in claim 1, further comprising a piston having a surface for receiving a cup thereon and configured for elevating the cup into the container responsive to receiving the discharged frozen beads.

7. A method of preparing a frozen bead coffee product, comprising the steps of:
maintaining an internal temperature in a chamber having a bottom wall, a side wall and a top wall within the range of −260° to −320° F.;
introducing droplets of a liquid at least including coffee into the chamber from the top wall thereof; whereby the liquid droplets form frozen beads upon contact with the liquid nitrogen gas;
rotating an auger having external flights, a distal end of the auger being positioned adjacent to the bottom of the chamber and a proximal end of the auger being adjacent to a sieve, whereby the frozen beads are lifted by the external flights and directed to the sieve;
sifting the frozen beads such that a portion of the frozen beads remain on the sieve and a portion of the frozen beads fall through the sieve holes into a collection pan; and
directing the remaining portion of frozen beads to a discharge, wherein the discharge chute feeds a container.

8. The method as recited in claim 7, wherein the step of maintaining an internal temperature in a chamber having a bottom wall, a side wall and a top wall within the range of −260° to −320° F. further comprising introducing liquid nitrogen into the chamber.

9. The method as recited in claim 8, wherein the liquid nitrogen is disposed on the bottom wall of the chamber.

10. The method as recited in claim 7, wherein the auger is mounted at an angle which is less than 90° relative to the plane formed by the bottom wall of the chamber.

11. The method as recited in claim 7, wherein the rotating auger deposits frozen beads on a supply chute directing the frozen beads to the sieve.

12. The method as recited in claim 7, wherein the sieve removes frozen beads less than about 2 millimeters.

13. The method as recited in claim 7, further comprising the step of elevating a cup into the container to receive the discharged frozen beads.

14. A vending machine for preparing and dispensing a frozen bead coffee product, comprising:
a chamber having a bottom wall, a side wall and a top wall, wherein the chamber is maintained at an internal temperature of less than or equal to about 18° C.;
a supply of a liquid at least including coffee;
a dispenser for introducing droplets of the liquid from the supply into the chamber, wherein the liquid droplets form frozen beads in the chamber;
an auger mounted for rotational motion, the auger having an elongated body with external flights extending into the chamber from an aperture in the top wall at an angle which is less than 90° relative to the plane formed by the bottom wall of the chamber, a distal end of the auger being positioned adjacent to the bottom wall of the chamber whereby the frozen beads are lifted by the external flights responsive to the rotational motion of the auger;
a chute positioned for receiving the frozen beads from the proximal end of the auger, wherein the frozen beads are lifted by the external flights of the auger and deposited into the chute by the proximal end of the auger;
a sieve mounted for vibrational motion positioned at the discharge end of the chute, wherein frozen beads and sifted by the vibrational motion of the sieve;
a discharge chute for receiving frozen beads flowing over the sieve;
a container for receiving the discharged frozen beads, wherein the container is maintained at a temperature below freezing; and
a piston having a surface for receiving a cup thereon and configured for elevating the cup into the container responsive to receiving the discharged frozen beads.

15. The vending machine as recited in claim 14, wherein the dispenser for introducing droplets of a liquid including coffee into the chamber comprises a tray having including a plurality of apertures positioned at the top wall of the chamber.

16. The vending machine as recited in claim 14, wherein the auger extends at about 45° relative to the plane formed by the bottom wall of the chamber.

17. The vending machine as recited in claim 14, wherein the sieve includes holes which have a diameter that is less than 2 millimeters.

18. The vending machine as recited in claim 14, wherein liquid nitrogen is introduced to the chamber to maintain the chamber at an internal temperature range of about −260° to about −320° F.

19. The vending machine as recited in claim 14, further comprising a housing including at least the container, the piston, a processor, memory and a display device.

20. The vending machine as recited in claim 19, wherein the processor is configured to communicate with the display device and memory to provide a user interface on the display device for facilitating a vending function, wherein the vending function includes detecting receipt of a monetary amount and actuating the discharge of frozen beads to the cup.
